(19) United States
(12) Patent Application Publication
(10) Pub. No.: US 2025/0195932 A1
(43) Pub. Date: Jun. 19, 2025

(54) SELF-HEALING FIREFIGHTING FOAM CONCENTRATES AND FIREFIGHTING FOAM COMPOSITIONS FOR CLASS A AND CLASS B FIRES

(71) Applicant: PERIMETER SOLUTIONS LP, Clayton, MO (US)

(72) Inventors: Leilei ZHANG, Green Bay, WI (US); Pamela HAVELKA-RIVARD, De Pere, WI (US); Carlson SUGIARTO, Green Bay, WI (US); Mark SIEM, Suamico, WI (US); Robert PAULICK, Green Bay, WI (US); Covadonga PEREZ, Mieres (ES); Monica FERNANDEZ AMANDI, Mieres (ES)

(21) Appl. No.: 18/985,847

(22) Filed: Dec. 18, 2024

Related U.S. Application Data
(60) Provisional application No. 63/612,131, filed on Dec. 19, 2023.

(51) Int. Cl. A62D 1/02

(52) U.S. Cl. CPC A62D 1/0071

(57) ABSTRACT

The present invention is generally directed to firefighting foam compositions, including concentrates, solutions (e.g., foam-forming solutions), and the foams produced from the concentrates and/or solutions. The compositions of the present invention are typically fluorine-free and contain a mixture of betaine surfactants, sulfate surfactants, and solvents that provide various advantageous performance characteristics. The compositions of the present invention are suitable for use for both Class A and Class B fires.

### REFERENCE TO RELATED APPLICATIONS

This application claims the benefit of, and priority to, U.S. Provisional Patent Application Ser. No. 63/612,131, filed Dec. 19, 2023, the entire contents of which are hereby incorporated by reference for all relevant purposes and as if fully set forth herein.

### FIELD OF THE INVENTION

The present invention is generally directed to firefighting foam compositions, including concentrates, solutions (e.g., foam-forming solutions), and the foams produced from the concentrates and/or solutions. The compositions of the present invention are typically fluorine-free and contain a mixture of betaine surfactants, sulfate surfactants, and solvents that provide various advantageous performance characteristics. The compositions of the present invention are suitable for use for both Class A and Class B fires.

### BACKGROUND OF THE INVENTION

Aqueous firefighting foams may be used for fighting Class A fires involving combustible materials including, for example, paper and wood. Aqueous firefighting foams are also used against Class B fires fueled by flammable liquids such as, for example, liquid fuels (e.g., jet fuel), gasoline and other hydrocarbons. Such firefighting foams include both aqueous film-forming foams (AFFF) and alcohol-resistant aqueous film-forming foams (AR-AFFF).

Previously, conventional AFFF and AR-AFFF foams contained fluorine. However, due to toxicity, bioaccumulation, and persistence concerns, in recent years fluorine-free aqueous firefighting foams have been developed. Suitable fluorine-free foams have been developed that overcome many if not all these issues and concerns identified with fluorine-containing foams. However, areas of improvement exist for such foams.

For example, there exists room for improvement in terms of performance criteria such as, for example, reduced fuel emulsification; applicability for use in a broader range of non-polar and polar fuels; similar performance in fresh, brackish, and salt water (e.g., seawater); and the expanded use in hardware typically used to protect industrial hazards in the petroleum, oil, and gas industries.

Specifically, for use on Class A fires areas for improvement include overall fire performance, including as measured and determined by the tests referenced herein. One area for improvement for so-called “Class A foams” that has been identified is in performance and stability under low temperature conditions (e.g., below about 35° F., or lower).

Areas for improvement identified in connection with “Class B foams” include performance when used in sprinklers and use in automotive fires.

### BRIEF SUMMARY OF THE INVENTION

Briefly, therefore, the present invention is directed to (fluorine-free) firefighting foam compositions (e.g., foam concentrates, foam forming solutions, and foams) comprising a betaine surfactant, one or more sulfate surfactants, and one or more solvents.

Other objects and features will be in part apparent and in part pointed out hereinafter.

### BRIEF DESCRIPTION OF THE FIGURES

FIG. 1 graphically displays the results of using certain components (e.g., tuning chemicals) in accordance with the present disclosure.

FIG. 2 displays suitable drain times for diluted concentrates (from dilution of 1.5 wt % to 6.0 wt %) of the present disclosure.

FIG. 3 displays the loss modulus of foams of the present disclosure following application and measured over time.

FIG. 4 provides a graphical description depicting low temperature performance of a composition of the present disclosure.

### DETAILED DESCRIPTION OF THE INVENTION

Described herein are firefighting foam compositions, e.g., foam concentrates, foam forming solutions, and foams suitable for use in a variety of environments, including in connection with both Class A and Class B fires. More particularly, described herein are fluorine-free firefighting foam concentrates that exhibit one or more advantageous properties and that provide foam solutions and foam compositions exhibiting one or more advantageous properties.

Various compositions of the present invention, including firefighting foam concentrates exhibit Newtonian rheology. Newtonian fluids exhibit viscosities that are independent of shear rate and thus such fluids exhibit water-like rheological properties. This viscosity behavior provides advantages in terms of ease in handling and allowing for use with existing and/or standard equipment. For example, the present concentrates do not require specialized equipment for handling, proportioning, etc., which is a significant advantage for users.

While water-like rheological properties may be desired for certain compositions such as the concentrates, other viscosity profiles may be desired for foam solutions, foams, etc. to provide performance improvements. For example, a diluted concentrate (e.g., foam-forming solution or foam) typically exhibits a viscosity that provides desirable performance upon foam application. Such viscosities are typically higher than the concentrate viscosity. The increase in viscosity occurs through aggregation, or assembly of surfactant molecules present in the composition. Overall, if a firefighting composition is prepared including a surfactant(s), these molecules will combine, or aggregate to produce a concentrate or composition having a higher viscosity than a composition that does not include the surfactants.

In accordance with the present invention, it has been discovered that including certain components, in particular certain surfactants, and at certain concentrations, provides concentrates exhibiting the desired rheological properties discussed above (i.e., Newtonian, or water-like) that can be used to provide foam compositions exhibiting acceptable or advantageous foam quality following dilution. Generally, the foam composition—or any other composition provided following dilution of the concentrate—exhibits a higher viscosity than the concentrate thus having undergone dilution thickening. In accordance with the present invention, it has been discovered that these certain component(s) (i.e., “tuning chemicals” or “tuning components”) provide resistance to an increase in viscosity for the concentrate through preventing aggregation or combining of the surfactant molecules within the concentrate. Upon dilution of the concentrate to form a solution and/or foam formation or application, sufficient dilution of the tuning chemicals occurs resulting in surfactant assembly and/or aggregation to provide desirable foam quality.

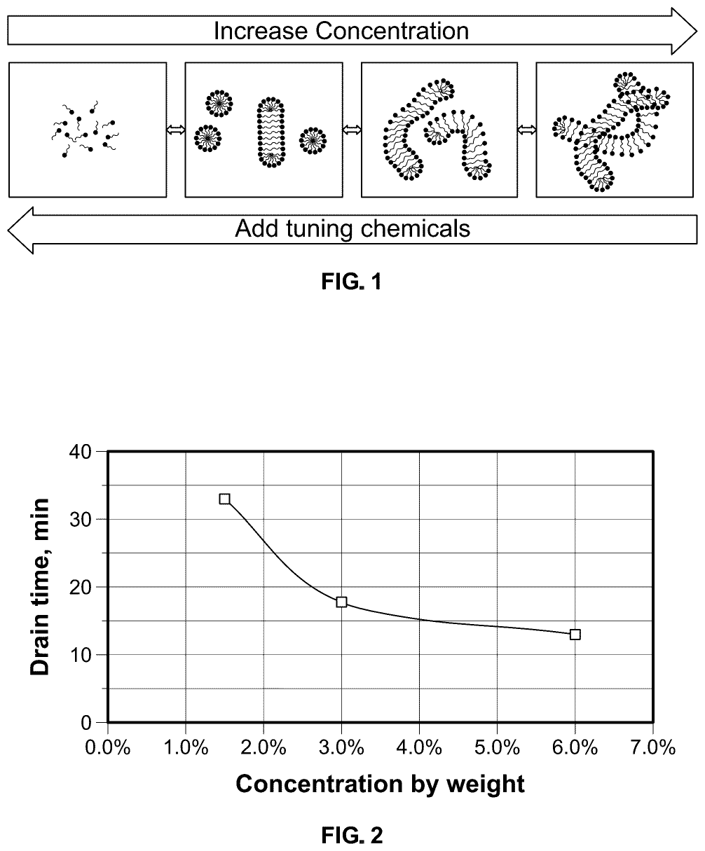

FIG. 1 graphically displays use of these certain components.

Dilution thickening of concentrates of the present invention provided by including one or more “tuning chemicals” may also be referred to as dilution resistance of the resulting foams. Quarter drain time (QDT) is one foam property for assessing dilution resistance of foams of the present invention. FIG. 2 indicates suitable drain times for diluted concentrates (from dilution of 1.5 wt % to 6.0 wt %). As shown, at increasing dilution—from 6.0 wt % concentrate to 1.5 wt % concentrate—the QDT increases thus indicating dilution thickening of the concentrate and dilution resistance of the resulting foam (and/or foam forming solution).

Similarly, the following Table provides a comparison of the QDT for a foam of the present invention and a typical Newtonian foam. As shown, at multiple concentrations/dilution levels, the foam of the present invention exhibits significantly higher QDT, specifically dilution of half strength (1.5 wt %), full strength (3 wt %), and double strength (6 wt %). As shown, foams diluted at a concentration of 1.5 wt % concentrate exhibit a QDT exceeding 30 minutes (min). Such QDTs have been provided by other compositions known in the art, but which typically include an additional component (e.g., a biopolymer or polysaccharide). Various embodiments of the present disclosure thus may be described as biopolymer-free and/or polysaccharide-free.

| | Half strength, | Full Strength, | Double Strength, |
|---|---|---|---|
| | QDT (min′sec) | QDT (min′sec) | QDT (min′sec) |
| WLM Foam | 33′00 | 17′13 | 13′00 |
| Typical | 1′50 | 9′08 | 13′23 |
| Newtonian foam | | | |
| (PHOS CHEK AB) | | | |

As noted, various embodiments of the present invention may be referred to as polymer-free (i.e., biopolymer-free or polysaccharide-free). Effective polymer-containing foam compositions are known and have been observed to provide foams of acceptable foam lifetime but may result in foams exhibiting relatively low foam strength. Compositions of the present invention exhibit suitable foam lifetime without requiring a polymer and therefore not suffering from potential foam strength issues.

The present invention is thus directed to concentrate compositions that when diluted and subjected to foam testing exhibit advantageous quarter drain times (QDT). For example, various concentrates of the present invention when diluted at concentrations of less than about 3 wt %, less than about 2.5 wt %, or less than about 2 wt % (e.g., about 1.5 wt % or about 1 wt) exhibit a QDT under foam testing of at least about 15 minutes, at least about 20 minutes, at least about 25 minutes, or at least about 30 minutes. Stated another way, concentrates of the present invention when diluted and subjected to foam testing may exhibit a QDT at least about 10 minutes, or at least about 15 minutes per unit concentration by weight of concentrate in the solution (diluted concentrate) subjected to foam testing.

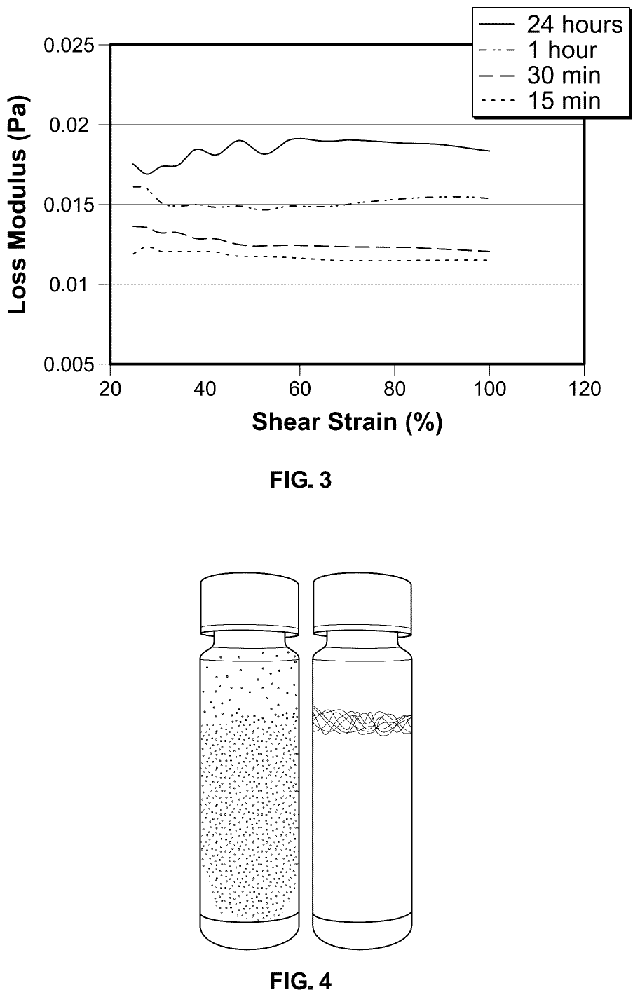

Foams of the present invention also exhibit delayed thickening involving an increase in the viscosity of the foam following application, which also may be termed a “self-healing” mechanism. FIG. 3 indicates such an increase as indicated by the loss modulus measured over time following application (at 15 minutes, 30 minutes, 1 hour and 24 hours, shown from bottom to top).

As shown, the loss modulus increases following application of the foam and over the course of the entire 24 hour period of testing. This increase in viscoelasticity of the foam following application is currently believed to provide enhanced vapor suppression. This enhanced vapor suppression is indicated by passing sprinkler testing results as detailed herein. This delayed thickening mechanism is currently believed to operate to provide a self-healing component of the foam where the foam repairs or addresses any weaknesses or lower performing sections through improved foam blanket quality provided by the increase in viscosity over time and following application.

Various concentrates of the present invention exhibit a dilution thickening aspect following dilution under certain conditions. Specifically, it is currently believed that concentrates when diluted at levels of about 5 wt %, about 6 wt, or about 7 wt %, e.g., from about 5 wt % to about 10 wt %, or from about 5 wt % to about 7 wt %, provide a solution having a higher viscosity than the concentrate prior to dilution, which exhibits Newtonian (i.e., water-like) rheology. While concentrates of the present invention may be utilized at a variety of dilution levels, including those below 5 wt. % (e.g., about 1 wt %, about 1.5 wt %, or about 3 wt %), this property of diluted concentrates is currently believed to be indicative of a composition that will provide desirable foam properties described herein (e.g., delayed thickening, self-healing, fire performance, etc.

Typically, a concentrate composition diluted with water to a concentration of about 5 wt %, about 6 wt %, about 7 wt %, about 8 wt. %, about 9 wt. %, or about 10 wt. %, will result in a solution exhibiting a viscosity following dilution that is greater than the concentrate viscosity prior to dilution by at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or even at least about 95% greater.

Concentrate viscosities prior to dilution are typically at least about 5 centipoise (cP), at least about 10 cP, at least about 15 cP, at least about 20 cP, at least about 25 cP, at least about 40 cP, at least about 50 cP and/or less than about 200 cP, less than about 175 cP, less than about 150 cP, or less than about 125 cP. Concentrate viscosity may be at, above, or below the above limits and/or within a range constructed from these lower and upper limits.

The compositions of the present invention generally include one or more surfactants, one or more solvents, and water. Other components may be included as well that have been observed to enhance fire performance. These include, for example, certain polymer compounds and certain alcohols (e.g., triols). Typically, the compositions of the present invention include a betaine surfactant, one or more sulfate surfactants (e.g., a first sulfate surfactant and a second sulfate surfactant), and a solvent.

### Surfactants

Generally, the compositions of the present invention include at least one zwitterionic surfactant (e.g., a betaine surfactant) and an anionic surfactant (e.g., a sulfate surfactant).

Suitable betaine surfactants include a positively charged amino group and a negatively charged carboxylic acid group along with a straight or branched chain alkyl group. The alkyl group typically contains at least (or about) 10 carbon atoms, at least (or about) 11 carbon atoms, at least (or about) 12 carbon atoms (e.g., 12 carbon atoms), at least (or about) 13 carbon atoms, or at least (or about) 14 carbon atoms.

Typically, the alkyl group contains from about 10 to about 18 carbon atoms (e.g., C10-C18), more typically from about 10 about 16 carbon atoms (e.g., C10-C16), still more typically from about 10 to about 14 carbon atoms (e.g., C10-C14), and even more typically from about 12 to about 14 carbon atoms (e.g., C12-C14).

In certain embodiments, the alkyl group of the betaine surfactant contains from about 12 to about 18 carbon atoms (e.g., C12-C18), more typically from about 12 about 16 carbon atoms (e.g., C12-C16), still more typically from about 12 to about 14 carbon atoms (e.g., C12-C14 or C12).

The alkyl group may be straight chain or branched.

In various embodiments, the composition may include more than one betaine surfactant and, thus, the total proportion of betaine surfactant may include an average alkyl group length (on a mass or molar basis) at or near the above limits or within the above ranges of chain length. Accordingly, the composition may include at least one betaine surfactant of a specified chain length, e.g., 12 carbon atoms, but may include other betaine surfactants of differing chain lengths such that the (weighted) average of alkyl group chain length may not be precisely 12.

Prior compositions include betaine surfactants having carbon chain lengths ranging from C8 to C16. Such compositions have not been observed to provide dilution resistance and delayed thickening properties. In contrast, compositions of the present invention exhibiting such properties typically include a betaine surfactant having an alkyl chain including from 10 to 14 carbon atoms, and typically 12 carbon atoms. More particularly, typically all or substantially all the betaine surfactant(s) included in the composition have a carbon chain length of from C10-C14 (e.g., C12). More particularly, typically at least about 80 wt %, at least about 85 wt %, at least about 90 wt %, at least about 95 wt %, or at least about 99 wt % of the betaine surfactant(s) included in the composition has a carbon chain length of C10-C14. More typically, at least about 80 wt %, at least about 85 wt %, at least about 90 wt %, at least about 95 wt %, or at least about 99 wt % of the betaine surfactant(s) included in the composition has a carbon chain length of C12.

Typically, an individual betaine surfactant or a combination of betaine surfactants is present in a concentration of at least about 1 wt %, at least about 2 wt %, at least about 3 wt %, at least about 4 wt %, at least about 5 wt %, at least about 10 wt %, at least about 12 wt %, at least about 14 wt %, at least about 15 wt %, or at least about 20 wt %. Additionally, or alternatively, the betaine surfactant(s) may be present in a concentration of less than about 50 wt %, less than about 40 wt %, less than about 30 wt %, less than about 20 wt %, less than about 17 wt %, less than about 16 wt %, less than about 14 wt %, less than about 12 wt %, less than about 8 wt %, less than about 7 wt %, less than about 6 wt %, or less than about 5 wt %. Moreover, any or all of the betaine surfactant(s) may be present within ranges of concentration constructed from any of the listed lower limits in combination with any of the listed upper limits.

In certain embodiments, the composition includes a betaine surfactant in a concentration of from about 10 wt % to about 50 wt %, from about 15 wt % to about 50 wt %, from about 15 wt % to about 45 wt %, from about 20 wt % to about 40 wt %, from about 25 wt % to about 40 wt %, or from about 30 wt % to about 40 wt %.

All concentrations listed are based on the total weight of the concentrate.

Along with the betaine surfactant(s) incorporated in accordance with the above discussion, the compositions of the present invention may include additional, shorter-chain betaine surfactants that may provide enhanced foam performance under certain conditions. For example, smaller carbon chain betaine surfactants including C6-C10 betaine surfactants (e.g., C7, C8, or C9 surfactants) may be included. These surfactants may be included at and/or within the concentration ranges listed above.

In various embodiments, the betaine surfactant content is relatively high and in any case above 15 wt % (e.g., about 16 wt % or higher). It is currently believed that including the betaine surfactant in such a proportion contributes, at least in part, to the advantageous foam properties discussed herein.

The concentrations of betaine surfactant listed above are suitable for concentrates diluted with water to a strength of 3 wt %, thus, where the concentrate contains about 15 wt % betaine surfactant the diluted concentrate (solution) would contain about 0.45 wt % betaine surfactant. In embodiments where the concentrate is intended for dilution to a lower concentration (e.g., about 1 wt % concentrate), thus a higher proportion of betaine surfactant can be incorporated in the concentrate, including concentrations at or near the upper limits of betaine surfactant listed above. For example, in various embodiments, the concentration of betaine surfactant may be from about 30 wt % to about 60 wt %, from about 35 wt % to about 50 wt %, or from about 40 wt % to about 50 wt % (e.g., about 45 wt %).

Conversely, where the concentrate will be used at higher concentrations, or less dilution (e.g., a strength of about 6 wt %), a betaine surfactant concentration at or near the lower end of the concentration ranges listed above may be utilized. For example, in various embodiments, the concentration of betaine surfactant may be from about 5 wt % to about 20 wt %, from about 5 wt % to about 15 wt %, or from about 5 wt % to about 10 wt % (e.g., about 7.5 wt %).

For proportions listed herein relative to concentrate compositions, it is to be understood that concentrations may be adjusted as necessary to provide the desired concentrations within the resulting solution or foam-forming composition.

Further in accordance with the present invention, the composition typically includes at least one sulfate surfactant. The at least one sulfate surfactant typically includes a straight chain or branched alkyl group having at least 10 carbon atoms. In various embodiments, the composition includes more than one sulfate surfactant (e.g., a first sulfate surfactant and a second sulfate surfactant). Reference to a “sulfate surfactant” below may refer to either or both of a first or second sulfate surfactant. More generally, the following discussion refers to any sulfate surfactant that may be present.

The alkyl group of the sulfate surfactant(s) typically contains at least (or about) 10 carbon atoms, at least (or about) 11 carbon atoms, at least (or about) 12 carbon atoms (e.g., 12 carbon atoms), at least (or about) 13 carbon atoms, or at least (or about) 14 carbon atoms.

Typically, the alkyl group contains from about 10 to about 18 carbon atoms (e.g., C10-C18), more typically from about 10 about 16 carbon atoms (e.g., C10-C16), still more typically from about 10 to about 14 carbon atoms (e.g., C10-C14), and even more typically from about 12 to about 14 carbon atoms (e.g., C12-C14).

In certain embodiments, the alkyl group of a sulfate surfactant contains from about 12 to about 18 carbon atoms (e.g., C12-C18), more typically from about 12 about 16 carbon atoms (e.g., C12-C16), still more typically from about 12 to about 14 carbon atoms (e.g., C12-C14 or C12).

In various embodiments, the alkyl group is a straight chain. In other embodiments, the alkyl group is branched.

As noted, in various embodiments the composition may include more than one sulfate surfactant and, thus, the total proportion of sulfate surfactant may include an average alkyl group length (on a mass or molar basis) at or near the above limits or within the above ranges of chain length.

Typically, an individual sulfate surfactant or a combination of sulfate surfactants is present in a concentration of at least about 1 wt %, at least about 2 wt %, at least about 3 wt %, at least about 4 wt %, at least about 5 wt %, at least about 10 wt %, at least about 12 wt %, at least about 14 wt %, at least about 15 wt %, or at least about 20 wt %. Additionally, or alternatively, the surfactant(s) may be present in a concentration of less than about 50 wt %, less than about 40 wt %, less than about 30 wt %, less than about 20 wt %, less than about 17 wt %, less than about 16 wt %, less than about 14 wt %, less than about 12 wt %, less than about 8 wt %, less than about 7 wt %, less than about 6 wt %, or less than about 5 wt %. Moreover, any or each of the sulfate surfactant(s) may be present within ranges of concentration constructed from any of the listed lower limits in combination with any of the listed upper limits.

For example, in certain embodiments a sulfate surfactant is present in a concentration of from about 1 wt % to about 30 wt %, from about 2 wt % to about 25 wt %, from about 5 wt % to about 20 wt % (e.g., from about 5 wt % to about 15 wt % or from about 10 wt % to about 20 wt %).

A sulfate surfactant may also be present in a concentration of from about 1 wt % to about 20 wt %, from about 1 wt % to about 15 wt %, or from about 2 wt % to about 10 wt %.

In various embodiments, the composition may include a first sulfate surfactant at from about 2 wt % to about 25 wt %, from about 2 wt % to about 20 wt %, from about 5 wt % to about 15 wt %; and a second sulfate surfactant constitutes from about 1 wt % to about 20 wt %, from about 2 wt % to about 15 wt %, or from about 2 wt % to about 10 wt %.

In various embodiments, the weight ratio of a betaine surfactant to a first sulfate surfactant is from about 4:1 to about 1:1; and/or the weight ratio of a betaine surfactant to a second sulfate surfactant is from about 20:1 to about 2:1; and/or the weight ratio of a first sulfate surfactant to a second sulfate surfactant is from about 20:1 to about 2:1.

Further, additional, shorter-chain sulfate surfactants that may provide enhanced foam performance under certain conditions can be included in the compositions as well. For example, smaller carbon chain sulfate surfactants including C6-C10 sulfate surfactants (e.g., C7, C8, or C9 surfactants) may be included. These surfactants may be included at and/or within the concentration ranges listed above.

### Solvents

Suitable solvents include glycols, including alkyl glycols, glycol ethers, and combinations thereof. Typically, a minimum proportion of the solvent is included to provide a thinning effect on the viscosity of the concentrate to allow for the dilution thickening effect on the viscosity of the diluted concentrate while nonetheless providing a concentrate with desired viscosity properties for preparation, handling, storage, etc.

Suitable glycol solvents, including alkyl glycols include C2-C10 glycols, C4-C8 glycols and C6-C8 glycols. In certain embodiments where the solvent comprises a glycol solvent, the solvent comprises or consists essentially of hexylene glycol (2-methylpentane-2,4-diol). In still other embodiments where the solvent comprises a glycol solvent, the solvent comprises or consists essentially of methyl propanediol (2-methyl-1,3-propanediol).

Suitable glycol ether solvents include C3-C10 glycol ethers, including C6-C10 glycol ethers. One example of a suitable glycol ether solvent is butyl CARBITOL (diethylene glycol monobutyl ether).

In certain embodiments, the composition comprises a solvent selected from the group consisting of hexylene glycol, propylene glycol, butyl carbitol, propylene glycol n-butyl ether (PnB), and combinations thereof.

In other embodiments, the composition comprises a solvent selected from the group consisting of hexylene glycol, propylene glycol, propylene glycol n-butyl ether, and combinations thereof.

In certain embodiments the solvent is or comprises hexylene glycol. In these and other embodiments, the solvent is or comprises butyl carbitol. In these and still other embodiments, the solvent is or comprises butyl carbitol and PnB.

Typically, the solvent is present in the concentrate in a proportion of at least about 0.1 wt %, at least about 0.5 wt %, at least about 1 wt %, at least about 2 wt %, at least about 3 wt %, or at least about 4 wt %. Generally, the solvent is present in a proportion of from about 0.1 wt % to about 14 wt % (e.g., from about 0.1 wt % to about 10 wt %), from about 2 wt % to about 15 wt % (e.g., from about 3 wt % to about 10 wt %, from about 4 wt % to about 10 wt %, from about 5 wt % to about 8 wt %, or from about 4 wt % to about 12 wt %).

In various embodiments, the composition comprises two solvents (i.e., a first solvent and a second solvent). In other embodiments, the composition comprises three solvents (i.e., a first solvent, a second solvent, and a third solvent). Typically, a second solvent and/or third solvent may constitute from about 1 wt % to about 20 wt % (e.g., from about 1 wt % to about 15 wt %), or from about 2 wt % to about 15 wt % (e.g., from about 2 wt % to about 12 wt %), based on the total weight of the concentrate.

In various embodiments, the weight ratio of a betaine surfactant to a solvent is from about 1:1 to about 1:0.3; and/or the weight ratio of a first sulfate surfactant to a solvent is from about 1:1 to about 1:0.2; and/or the weight ratio of a second sulfate surfactant to a solvent is from about 10:1 to about 1:70.

### Performance Enhancing Components

Components in addition to a surfactant(s) and solvent(s) in accordance with the preceding discussion may be incorporated as well. These include an additional surfactant selected from those listed above, other types of surfactants, polymeric compounds, and certain alcohol compounds. As described herein, including the working examples, it is currently believed that these components enhance performance of the firefighting foam in certain aspects.

Suitable components include propionate surfactants (e.g., iminodipropionate surfactants). Other suitable components include sulfate surfactants, including sulfate surfactants containing up to 10 or up to 6 ethylene oxide (EO) units. Other suitable components include polymers selected from polyethylene glycol (PEG), including PEG having a molecular weight of greater than about 1000. Other suitable compounds include alcohols selected from triols selected from the group glycerin, ethylene glycol, propylene glycol, and combinations thereof. Mixtures and combinations of these components may be incorporated as well.

Typically, any additional (performance enhancing) component is present in a concentration of at least about 0.1 wt %, at least about 0.2 wt %, at least about 0.3 wt %, at least about 0.4 wt %, at least about 0.5 wt %, at least about 1.0 wt %, at least about 1.2 wt %, at least about 1.4 wt %, at least about 1.5 wt %, or at least about 2.0 wt %. Additionally, or alternatively, the additional component(s) may be present in a concentration of less than about 25 wt %, less than about 20 wt %, less than about 15 wt %, less than about 10 wt %, less than about 5 wt %, or less than about 3 wt %. Moreover, any or all of the additional component(s) may be present within ranges of concentration constructed from any of the listed lower limits in combination with any of the listed upper limits.

Along with the components listed above, the concentrates include water.

Typically, the foam concentrate contains at least about 10 wt %, at least about 15 wt %, at least about 20 wt %, at least about 25 wt %, at least about 30 wt %, at least about 35 wt %, at least about 40 wt %, at least about 45 wt %, or at least about 50 wt %. Overall, these foam concentrates typically contain less than about 80 wt %, less than about 75 wt %, less than about 70 wt %, less than about 65 wt %, less than about 60 wt %, less than about 55 wt %, or less than about 50 wt %. In accordance with the present disclosure, the concentrates generally contain water in a proportion within a range of concentration constructed by a lower limit and upper limit listed above.

Typically, compositions of the present invention include the components listed above. Specifically, in various embodiments, the compositions include only one or more surfactants and one or more solvents along with water. In this manner, the compositions may consist essentially of or consist of these components. Further in accordance with the foregoing discussion, these compositions may also include one or more performance enhancers. In this manner, the composition may consist essentially of or consist of one or more surfactants, one or more solvents, and one or more performance enhancers along with water.

As noted, foam concentrates of the present invention exhibit Newtonian viscosity (i.e., viscosity independent of shear rate) and provide a thickening effect upon dilution (i.e., an increase in viscosity). That is, diluted concentrates (e.g., firefighting foam solutions) exhibit higher viscosities than the underlying concentrates (i.e., the firefighting foam solution exhibits solution thickening behavior). This viscosity behavior and the combination(s) of components that provide this behavior are believed to provide firefighting foams that exhibit a myriad of advantageous performance characteristics as detailed herein (e.g., long drain times, etc.). In addition, the viscosity behavior (e.g., water-like properties of the concentrate and foam solution) provides ease in handling and allows for use with existing and/or standard equipment. That is, the current concentrates do not require specialized equipment, which is a significant advantage for users.

Generally, the firefighting foam concentrates provide diluted compositions, i.e., solutions that are micellar in that there is an aqueous (bulk) phase having the surfactant molecules and other components distributed throughout. It is currently believed the viscosity behavior of the concentrates and foam solutions and the advantageous and improved performance characteristics for the foam compositions are provided, in part, by the nature of micelle formation within the foam solutions (i.e., a diluted concentrates). These micellar formulations of the foam solutions (diluted concentrates) include structures constructed from the surfactant molecules via a self-assembly mechanism during and/or upon dilution of the concentrate. These micelle structures constructed from the surfactant molecules are believed to be wormlike structures formed from aggregation of the surfactant molecules. In particular, the wormlike structures are believed to be formed from aggregation of surfactant molecules essentially in one direction, lengthwise. The self-assembled micelle structures are believed to function as a dynamic network similar to a polymer solution and display viscoelastic properties upon dilution.

In accordance with the present invention, formation of the self-assembled surfactant micelles upon dilution of the concentrate is controlled, at least in part, by selection of the betaine and sulfate surfactants included. For example, it has been discovered that selection of a betaine surfactant having an alkyl group of a specific chain length may provide such control. Typically, the composition of the present invention includes a betaine surfactant having an alkyl group with a carbon chain containing from 10 to 14 carbon atoms (C10-C14) and, more typically, having a carbon chain of 12 carbon atoms (C12). Further in accordance with the present disclosure, the compositions typically contain a sulfate surfactant having an alkyl group with a carbon chain containing from 10 to 14 carbon atoms (C10-C14) and, more typically, having a carbon chain of 12 carbon atoms.

Control of the dilution thickening of the concentrates following dilution and resulting dilution resistance of resulting foams is primarily believed to be controlled by the selection of an additional surfactant and/or the solvent.

For example, in various embodiments along with the C10-C14 (e.g., C12) betaine surfactant and C10-C14 (e.g., C12) sulfate surfactant a second sulfate surfactant is typically included along with a solvent selected from those listed herein. More particularly, to provide the desired combination of concentrate dilution thickening and foam dilution resistance a second sulfate surfactant having a carbon chain length of from 10 to 14 carbon atoms (C10-C14, e.g., C12) is included. More particularly, the solvents are included of a type and in a concentration that dilutes the surfactants sufficiently to prevent their aggregation prior to dilution of the concentrates. The surfactants are thus present in the concentrate but un-aggregated or combined, thus resulting in the concentrate having Newtonian viscosity and the resulting foam exhibiting dilution resistance following dilution of the concentrate promoting aggregation of the surfactant molecules.

A sufficient proportion of solvent is needed in the concentrate to prevent self-assembly of the surfactant micelles prior to dilution, while also incorporating the solvent at a concentration that results in a sufficiently dilute foam solution that promotes formation of the micellar structures to provide the desired viscosity behavior.

Overall, the concentrates of the present invention are formulated to provide a desired concentrate viscosity (e.g., less than about 200 centipoise (cP), or “water-like”) and viscosity behavior that results in a thickening effect upon dilution (e.g., providing a firefighting foam solution having a viscosity that is 10%, or more, higher than the viscosity of the concentrate).

Stated another way, preparing the concentrate of the present invention involves including one or more betaine and/or sulfate surfactants along with one or more solvents wherein the one or more solvents have a minimum solubility in a liquid medium comprising the one or more betaine and/or sulfate surfactants. That is, while C10-C14 betaine surfactants and C10-C14 sulfate surfactants are listed above, the compositions of the invention can be characterized in this manner as well.

Typically, the viscosity of the concentrate upon dilution (i.e., after preparing a firefighting foam solution, or foam forming composition prior to aspiration), is at least about 5%, at least about 10%, or at least about 20% greater than the viscosity of the concentrate.

Generally, the viscosity of the concentrates of the present invention is at least about 5 centipoise (cP) or from about 10 cP to about 200 cP. The viscosity of diluted concentrates is typically at least about 2 cP or from about 15 cP to about 500 cP.

### Foam Solutions

Typically, foam solutions of the present invention contain at least or about 0.5 wt %, 1 wt %, 2 wt %, 3 wt %, 4 wt %, 5 wt %, or 6 wt % of the foam concentrate. That is, the foam solutions are typically prepared from the foam concentrate by dilution with water at a dilution ratio (concentrate:water) of from 1:99 to 6:94.

As discussed above, the foam solutions of the present invention exhibit dilution-thickening as compared to the underlying foam concentrate.

Typically, the viscosity of the concentrate upon dilution (i.e., after preparing a firefighting foam solution, or foam forming composition prior to aspiration), is at least about 5%, at least about 10%, or at least about 20% greater than the viscosity of the concentrate. Additionally, or alternatively, the viscosity of the foam solution is typically at least about 5 cP, at least about 50 cP, at least about 100 cP, at least about 150 cP, at least about 200 cP, at least about 210 cP, at least about 220 cP, at least about 230 cP, at least about 240 cP, or at least about 250 cP. Overall, solution viscosity is typically from about 2 cP to about 500 cP, from about 5 cP to about 500 cP, from about 50 cP to about 400 cP, or from about 100 cP to about 300 cP.

### Foams

Generally, the foams of the present invention are prepared by aspirating a foam solution of the present invention. Advantageously, the foams of the present invention exhibit enhanced fire performance and/or suitable or advantageous fire performance under certain conditions.

Compositions of the present invention pass various fire performance tests. These include the following military specifications (Milspec) for use in Class B fires: Gasoline (for a 3 wt % concentrate solution); Jet A (for a 3 wt % concentrate solution); Jet A (for a 1.5 wt % concentrate solution); Jet A Purple K (for a 3 wt % concentrate solution); Jet A (for a 6 wt % concentrate solution); Jet A 50 ft² (for a 3 wt % concentrate solution); Gasoline (for an aged 3 wt % concentrate); Jet A (for a 3 wt % aged concentrate solution); Jet A (for a 1.5 wt % aged concentrate solution). Aged concentrations in these tests are those that have been stored in a 60° C. oven for 10 days.

In various embodiments, the composition passes one or more of these tests. In certain embodiments, the composition passes each of these tests.

Compositions of the present invention also pass Underwriters Laboratory (UL) 162 sprinkler test. In particular, the composition typically passes either or both the extinguishment and/or water deluge portion of this test. Typically, the composition passes both the extinguishment and water deluge portion.

Further in accordance with the present invention, it has advantageously been discovered that thickener-free compositions (i.e., compositions free of a polysaccharide thickener such as diutan gum, xanthan gum, and welan gum) of the present invention pass the UL 162 sprinkler test, in particular the water deluge portion.

Compositions of the present invention also pass Milspec sprinkler testing V20-199.

These and other compositions of the present invention pass Factory Mutual (FM) sprinkler testing standard 5130. In accordance with the present invention, it is currently believed the fluorine-free compositions of the present invention are the first fluorine-free composition to meet this standard.

Compositions of the present invention also pass wetting tests for use in assessing foams for use in Class A foams in accordance with United States Forest Service (USFS) standards.

Compositions of the present invention also pass the Chubb Vehicle Fire test for Class B performance.

As noted above, foams of the present invention exhibit one or more advantageous properties in use and/or provide one or more efficiencies. In particular, the performance achieved may exceed the performance provided by earlier foams. For example, longer drain times have been observed for the current foams as compared to fluorinated foams. By way of further example, suitable performance for the properties detailed below are provided while the foams are suitable for use with standard equipment and with any suitable water source (i.e., the end user does not need to be concerned whether fresh or saltwater is to be used).

Compositions of the present invention also pass saltwater (SW) performance tests, including Milspec Class B jet fuel tests.

### Low Temperature Performance

Further in accordance with the present invention, the compositions of the present invention exhibit suitable and/or advantageous stability properties and performance under low temperature conditions. This stability under low temperature conditions can be indicated visually where a composition of the present invention remains stable following storage at 35° F. as indicated by water-like appearance following such storage while other compositions appear cloudy and/or include portions that appear to be or are frozen. Please see FIG. 4 for a depiction of such a “frozen” composition (A) and water-like composition of the present disclosure (B) following low-temperature storage.

This low temperature stability provides advantages in practice by providing compositions passing performance tests (e.g., Military Specification, Milspec) over wide temperature ranges (e.g., from about 35° C. to about 60° C.).

### Methods for Fighting Fires

The compositions and foams of the present invention are suitable for use in methods for combatting and/or extinguishing Class A and Class B fires where a composition or foam composition is applied directly or indirectly onto a Class A or Class B fire or the fuel ahead of a potentially advancing Class A or Class B fire front.

Described herein are fluorine-free firefighting compositions, e.g., concentrates, foam solutions, foam-forming solutions, and foams. Fluorine-free may refer to and typically refers to compositions that do not include fluorine. Fluorine-free may also refer to compositions that do not include any fluorinated compound, such as a fluorinated surfactant, and polymers. In various embodiments, the compositions may be nearly entirely free of fluorine, or essentially free of fluorine. In such instances, the composition does not include added fluorine or fluorine-containing compounds. However, although not preferred, water or components of the compositions of the invention may include some minor portion of fluorine, but the compositions are nonetheless “fluorine-free” as defined herein and as understood in the art. Overall, any minor portion of fluorine does not exceed 1 part per trillion (ppt) or 0.1 ppt of the composition.

Having described the invention in detail, it will be apparent that modifications and variations are possible without departing from the scope of the invention defined in the appended claims.

### EXAMPLES

The following non-limiting examples are provided to further illustrate the present invention.

### Example 1

The following Example describes formulations of the present invention. Compositions of the present invention including Package 1 and Package 2 have been observed to exhibit advantageous fire performance.

| | | Wt % |
|---|---|---|
| Package 1 | Betaine surfactant (C12) | 16-45 |
| | 1^{st} sulfate surfactant (C12) | 5-20 |
| Package 2 | 2^{nd} sulfate surfactant (C12) | 2-20 |
| | Solvent | 3-13 |

### Example 2

Compositions of the present invention may further include the following components, which in various embodiments improve low temperature performance and stability:

| | | wt % |
|---|---|---|
| Package 3 | Solvent 1 | 3-13 |
| | Solvent 2 | 4-16 |

### Example 3

Compositions of the present invention may also include the following components, which in various embodiments have been observed to provide improved foam properties, including improved burnback and fire performance:

| | | wt % |
|---|---|---|
| Package 4 | C8-C16 propionate | 0-5.5 |
| | Sulfate with 0-6 EO | 0.1-3 |
| | Glycerin | 3-25 |
| | Polyethlyene glycol | 0-5 |

### Example 4

Following are results of testing for compositions of the present invention. As shown, the compositions pass numerous tests thus indicating the suitability of the compositions of the present invention for use in a variety of situations.

| Test Type | Results | Notes |
|---|---|---|
| Milspec | Pass | Class B, Pass SW Jet fuel |
| UL 162 Sprinkler | Pass extinguishment | Class B |
| FM Sprinkler | Pass | 1^{st} reported in industry |
| Wetting Test | Pass Draves test | Class A, US Forest service |
| | (time <12 seconds) | |
| Vehicle Fire | Pass | Class B |
| AS-5062 | | |

Milspec fire test results. The “aged” designation indicates the foam concentrate was stored in an oven at a temperature of 60° C. for 10 days prior to use.

| Fuel | Concentration, % | Extinguishment, sec | Burnback | Notes |
|---|---|---|---|---|
| Gas | 3 | 52 | 4′05 | Pass |
| Jet A | 3 | 27 | 7′40 | Pass |
| Jet A | 1.5 | 30 | 6′35 | Pass |
| Jet A | 3 | 29 | 5′55 | Pass |
| purple K | | | | |
| Jet A | 6 | 25 | 7′50 | Pass |
| Jet A 50 ft² | 3 | 35 | 5′50 | Pass |
| Gasoline | aged 3 | 55 | 4′17 | Pass |
| Jet A | aged 3 | 25 | 5′40 | Pass |
| Jet A | aged 1.5 | 25 | 6′37 | Pass |
| Jet A | 3 in saltwater | 29 | 5′16 | Pass |

### Example 5

Following is a description of a foam concentrate composition of the present disclosure suitable for preparing a product at dilution of 3 wt %.

| Component | Wt % |
|---|---|
| Propylene glycol n-butyl ether | 2-10 |
| Polyethylene glycol | 1-5 |
| Diethylene glycol monobutyl ether | 2-10 |
| C8-C22 betaine surfactant | 5-20 |
| C8-C16 propionate surfactant | 1-5 |
| C6-C10 sulfate surfactant | 0.1-5 |
| C10-C14 sulfate surfactant | 2-15 |
| Water | 30-50 |

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that several objects of the invention are achieved and other advantageous results attained.

As various changes could be made in the above without departing from the scope of the invention, it is intended that all matter contained in the above description shall be interpreted as illustrative and not in a limiting sense.

What is claimed is:

1. A fluorine-free firefighting foam concentrate, the concentrate comprising:
a betaine surfactant;
a first sulfate surfactant;
a second sulfate surfactant; and
a solvent selected from the group consisting of hexylene glycol, propylene glycol, propylene glycol n-butyl ether, and combinations thereof, wherein the concentrate is free of any polysaccharide and/or biopolymer thickener.

2. A fluorine-free firefighting foam concentrate, the concentrate comprising:
a C10-C14 betaine surfactant;
a first C10-C14 sulfate surfactant;
a second C10-C14 sulfate surfactant; and
a solvent selected from glycols, glycol ethers, and combinations thereof; wherein the concentrate is free of any polysaccharide and/or biopolymer thickener.

3. A fluorine-free firefighting foam concentrate, the concentrate comprising:
a C10-C14 betaine surfactant;
a first C10-C14 sulfate surfactant;
a second C10-C14 sulfate surfactant; and
a solvent selected from glycols, glycol ethers, and combinations thereof, wherein:
the betaine surfactant is present in a concentration of from about 10 wt % to about 50 wt %, based on the total weight of the concentrate;
the first sulfate surfactant constitutes from about 2 wt % to about 25 wt %, based on the total weight of the concentrate;
the second sulfate surfactant constitutes from about 1 wt % to about 20 wt %, based on the total weight of the concentrate; and
the solvent constitutes from about 2 wt % to about 15 wt %, based on the total weight of the concentrate.

4. The concentrate of claim 1, wherein the betaine surfactant is a C12 surfactant.

5.-8. (canceled)

9. The concentrate of claim 1, wherein the solvent comprises butyl carbitol and PnB.

10. The concentrate of claim 1, wherein:
the weight ratio of the betaine surfactant to the first sulfate surfactant is from about 4:1 to about 1:1; and/or
the weight ratio of the betaine surfactant to the second sulfate surfactant is from about 20:1 to about 1:0.5; and/or
the weight ratio of the first sulfate surfactant to the second sulfate surfactant is from about 20:1 to about 2:1.

11. The concentrate of claim 1, wherein:
the weight ratio of the betaine surfactant to the solvent is from about 1:1 to about 1:0.3; and/or
the weight ratio of the first sulfate surfactant to the solvent is from about 1:1 to about 5:1; and/or
the weight ratio of the second sulfate surfactant to the solvent is from about 10:1 to about 1:70.

12. The concentrate of claim 1, wherein the concentrate further comprises at least one additional solvent selected from the group consisting of hexylene glycol, propylene glycol, butyl carbitol, propylene glycol n-butyl ether (PnB), and combinations thereof.

13.-22. (canceled)

23. The concentrate of claim 2, wherein the concentrate further comprises a fire performance enhancer comprising:
a further surfactant, selected from propionate surfactants, sulfate surfactants, and combinations thereof, and/or
polymers selected from polyethylene glycol (PEG) (e.g., PEG having a molecular weight above 1000), and combinations thereof, and/or
a triol compound selected from glycols and glycerols selected from the group consisting of glycerin, ethylene oxide, and combinations thereof.

24. The concentrate of claim 23, wherein the fire performance enhancer comprises:
a C8-C16 propionate surfactant;
a sulfate surfactant containing from 0-6 EO;
glycerin; and
PEG.

25. The concentrate of claim 23, wherein the fire performance enhancer comprises a propionate surfactant and/or sulfate surfactant in a concentration of from about 0.1 wt % to about 5 wt %, or from about 0.1 wt % to about 3 wt %, a polymer in a proportion of from about 0.1 wt % to about 5 wt %, and/or a triol in a proportion of from about 1 wt % to about 25 wt %.

26. The concentrate of claim 23, wherein the fire performance enhancer comprises a polymer in a proportion of from about 0.1 wt % to about 5 wt %.

27.-28. (canceled)

29. A fire retardant solution, the solution prepared by diluting with water the fire retardant concentrate of claim 1, wherein the solution passes the following military specifications (Milspec) for use in Class B fires:
Gasoline (for a 3 wt % concentrate solution)
Jet A (for a 3 wt % concentrate solution)
Jet A (for a 1.5 wt % concentrate solution)
Jet A Purple K (for a 3 wt % concentrate solution)
Jet A (for a 6 wt % concentrate solution)
Jet A 50 ft² (for a 3 wt % concentrate solution)
Gasoline (for a 3 wt % aged concentrate solution)
Jet A (for a 3 wt % aged concentrate solution)
Jet A (for a 1.5 wt % aged concentrate solution)

30. A fire retardant solution, the solution prepared by diluting with water the fire retardant concentrate of claim 1, wherein the solution passes Underwriters Laboratory (UL) standard 162 sprinkler testing for use in commercial/industrial applications, the solution passing the extinguishment portion and/or water deluge portion of UL 162.

31.-32. (canceled)

33. A fire retardant solution, the solution prepared by diluting with water the fire retardant concentrate of claim 1, wherein the solution passes Factory Mutual (FM) sprinkler testing standard 5130.

34. A fire retardant solution, the solution prepared by diluting with water the fire retardant concentrate of claim 1, wherein the solution passes Military Specification (Milspec).

35. A fire retardant solution, the solution prepared by diluting with water the fire retardant concentrate of claim 1, wherein the solution passes the United States Forest Service (USFS) wetting test for Class A fire performance.

36. A fire retardant solution, the solution prepared by diluting with water the fire retardant concentrate of claim 1, wherein the solution passes Vehicle Fire AS-5062 test for Class B fire performance.

37. A firefighting foam prepared from the concentrate of claim 1, wherein the foam is a Newtonian foam.

38. (canceled)

39. The firefighting foam of claim 37 wherein the foam exhibits a quarter drain time (QDT) of at least about 10 minutes, at least about 15 minutes, at least about 20 minutes, at least about 25 minutes, at least about 30 minutes, at least about 35 minutes, or at least about 40 minutes.
